(19) United States
(12) Patent Application Publication
(10) Pub. No.: US 2018/0017030 A1
(43) Pub. Date: Jan. 18, 2018

(54) PLUNGER ASSEMBLY

(71) Applicant: Delphi International Operations Luxembourg S.A.R.L., Bascharage (LU)

(72) Inventors: Kevin J. Laity, Gillingham, Kent (GB); Ian Roy Thornthwaite, Gillingham, Kent (GB)

(21) Appl. No.: 15/545,934

(22) PCT Filed: Dec. 2, 2015
(86) PCT No.: PCT/EP2015/078413

§ 371 Date: Jul. 24, 2017

(30) Foreign Application Priority Data
Jan. 27, 2015 (GB) 1501282.6

(51) Int. Cl. F02M 59/02; F02M 59/44

(52) U.S. Cl. CPC F02M 59/02; F02M 59/442

(57) ABSTRACT

A plunger assembly for a high pressure fuel pump head, wherein an axial internal drilling provided in a first plunger section, and a clearance between the first and a second plunger section, are exposed to a pumping fuel pressure, and wherein a pressure gradient along an outside wall of the first section and the bore, and pressure within the drilling and clearance, results in an increasing deformation of the first section and thereby a decreasing clearance between the first section and the bore, moving towards the second section, thereby providing sealing from one end of the plunger to the opposite end.

### CROSS REFERENCE TO RELATED APPLICATIONS

This application is a national stage application under 35 USC 371 of PCT Application No. PCT/EP2015/078413 having an international filing date of Dec. 2, 2015, which is designated in the United States and which claimed the benefit of GB Patent Application No. 1501282.6 filed on Jan. 27, 2015, the entire disclosures of each are hereby incorporated by reference in their entirety.

### TECHNICAL FIELD

The present invention relates to a fuel pump for an internal combustion engine, and in particular to a plunger assembly for a pump head for a high pressure fuel injection system such as a diesel fuel injection system.

### BACKGROUND OF THE INVENTION

Known fuel pumps for high pressure fuel injection systems, such as a common rail diesel application, typically comprise a pump head and a plunger which is reciprocally moveable within a bore thereby to establish a pressure difference. To ensure the necessary pressure difference is achieved, a sealing length is provided, comprising a minimal clearance between the plunger and bore. The sealing length and the clearance between the plunger and bore are two factors which define the volumetric efficiency (VE) of the pump.

To ensure that OEMs can meet CO2 efficiency targets, fuel injection systems are running at higher pressures. A known problem of pump heads running at enhanced pressures is a reduction in the VE of the pump head.

An example of a known hydraulic pump head is illustrated in FIG. 1. The pump head 2 comprises a pump housing 4 including a turret portion 10, an inlet valve arrangement 70, and an outlet valve arrangement 80. A plunger 6 arranged for reciprocal movement within a bore 8 provided in the housing 4.

The pump head 2 illustrated in FIG. 1 represents a current pump head design suitable for high pressure applications, such as 2000 bar or higher.

Due to the configuration of the outlet port 80 in the prior art pump 2, a chamber or annulus 42 is provided which opens above the plunger guiding length. The annulus 42 ensures that the fuel pumped by the plunger is not restricted.

Current hydraulic pump head design has been constrained by several factors, such as:
external packaging constraints, such as restriction of leakage length due to restriction of pump height;
internal pump packaging constraints, such as restriction of turret stiffness due to restriction of turret outer diameter;
plunger bore clearance, defined by manufacturing capability of the plunger and the bore.

The prior art pump head design as discussed above exhibits a reduction in VE at higher pressures. An increase in clearance between the plunger and the bore while operating at elevated pressures results in an increased leakage.

A further known pump head design, suitable for use in heavy duty applications, is partially illustrated in FIG. 2. This embodiment of head plunger assembly is not reliant on a long leakage length having a specific clearance to reduce leakage. Rather it utilises a short length of very tight clearance.

The plunger 206, which is reciprocally movable within a barrel 266, is provided with an internal central drilling 248. A recess 264 is provided in the plunger 206, leaving a full diameter section 268 at the top end of the plunger 206, which has a tight clearance with the bore 208. Sealing is provided by this tight clearance; sealing may be over a relatively short length, such as 2mm. A relatively short sealing length reduces the necessary depth of the drilling 248, thereby reducing dead volume.

The known pump head of FIG. 2 operates as follows:
fuel pressure is increased by the movement of the plunger 206;
central drilling 248 is exposed to high pressure, whereas the clearance between the full diameter section 268 and the bore 208 is subjected to a pressure gradient, decreasing from a highest pressure at the top (in the orientation of FIG. 2), to a cambox or return line pressure at recess 264;
a tip of the plunger 206 expands due to the effect of a resulting pressure difference;
clearance between the sealing land and the barrel 266 is reduced;
flow of high pressure fuel through the clearance is minimised.

### SUMMARY OF THE INVENTION

It is an object of the present invention to provide an improved plunger assembly for a high pressure pump head.

Accordingly the present invention provides, in a first aspect, a plunger assembly according to claim 1.

The present invention enables an efficient plunger design to be integrated into different hydraulic pump head designs, for example with different configurations of outlet valve, without incurring a significant dead volume penalty.

The first section of the plunger assembly may comprise an expanding zone wherein, during use of the pump head, the expanding zone is caused to expand by fuel pressure within the clearance and thereby form a zone of minimum clearance between the first section and the bore.

The internal portion of the plunger assembly which is subjected to a pumping fuel pressure may comprise an internal drilling, and a clearance between the first section and the second section, wherein the internal drilling opens at a first end remote from the second section of the plunger assembly onto the chamber, and opens at a second end onto the clearance.

The pressure reducing feature may comprise a radial recess which extends over portions of outer diameters of the first section and the second section of the plunger assembly and which, during use of the pump head is exposed to a fuel feed, cambox or return line fuel pressure.

The pressure reducing feature may alternatively comprise axial grooves.

In one embodiment, an extension section of the second section of the plunger assembly is retained within a recess provided in the first section by an interference fit along an interference zone between the extension section and an annular wall section which circumferentially defines the recess.

The present invention further comprises a pump head for a high pressure fuel pump for a vehicle, comprising a plunger assembly as described above.

### BRIEF DESCRIPTION OF THE DRAWINGS

The present invention is now described by way of example with reference to the accompanying drawings in which:

FIGS. 1 and 2 are cross-sectional views of a known hydraulic pump head and a portion of a known pump head design respectively;

FIG. 3 is a cross-sectional view of a pump head in accordance with the present invention;

FIG. 4 is a cross-sectional view of a plunger assembly in accordance with the present invention; and

FIG. 5 is a cross-sectional partial view of the plunger assembly of FIG. 4.

### DESCRIPTION OF THE PREFERRED EMBODIMENTS

An embodiment of the present invention is described below in relation to the orientation of the figures. Terms such as upper, lower, above, below, top and bottom are not intended to be limiting.

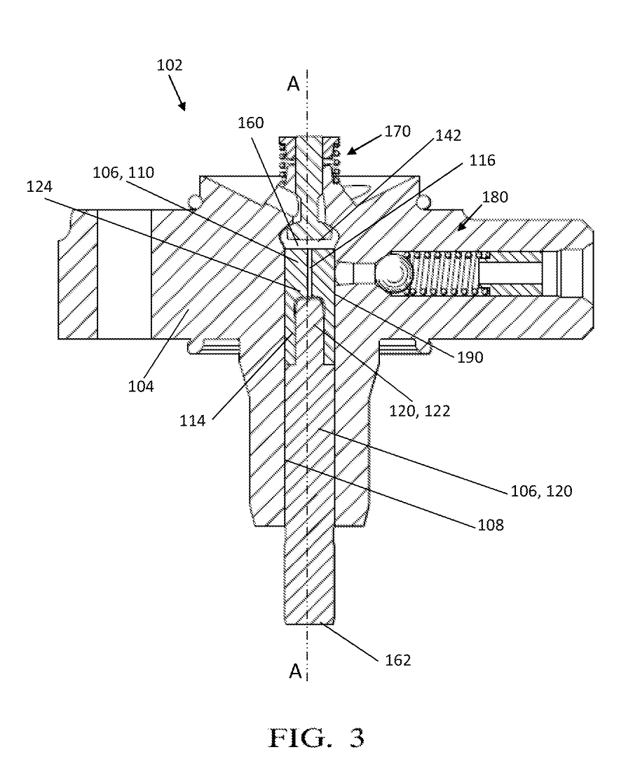

Referring to FIGS. 3 to 5, a pump head 102 in accordance with the present invention comprises a pump body or pump housing 104, an inlet valve arrangement 170 (indicated on FIG. 3) and an outlet valve arrangement 180 (indicated on FIG. 3). The pump housing 104 is provided with a bore 108 extending along a longitudinal axis A.

A plunger assembly 106 is located within the bore 108. A chamber, or annulus 142 (indicated on FIG. 3) is provided within the bore 108 above a first, upper end 160 of the plunger assembly 106.

The plunger assembly 106 is reciprocally movable within the bore 108 along the longitudinal axis A, by force transferred from a cam arrangement (not shown) to a second, lower end 162 of the plunger assembly 106.

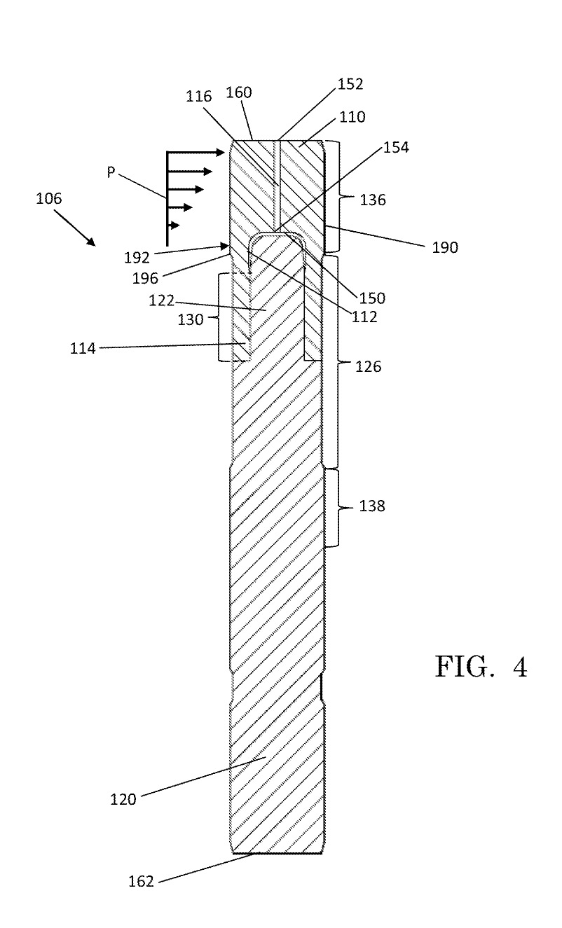

The plunger assembly 106 is guided within the bore by guidance zones 136, 138 (both indicated on FIG. 4).

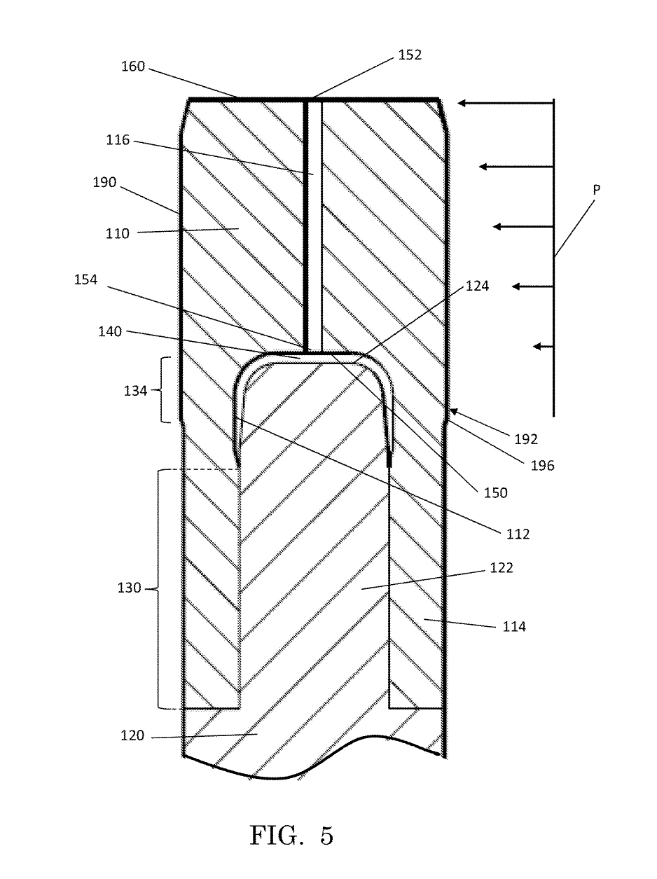

The plunger assembly 106 comprises two parts; a first, upper section, 110 and a second, lower section 120. An extension section 122 of the second, lower section 120 extends into a recess 112 (indicated in FIGS. 4 and 5) provided in the first, upper section 110 and defined circumferentially by an annular wall section 114. As explained in greater detail below, the annular wall section 114 comprises an expanding zone 134 (indicated on FIG. 5), and an interference zone 130 (FIGS. 4 and 5).

The first, upper section 110 and the second, lower section 120 are retained together by a retaining means, which in the embodiment illustrated in FIGS. 3 and 4 comprises an interference fit along the interference zone 130, between the extension section 122 and the annular wall section 114 which circumferentially defines the recess 112.

Between an end 124 (indicated in FIG. 5) of the extension section 122 of the second, lower section 120 of the plunger assembly 106, and a base 150 (indicated on FIGS. 4 and 5) of the recess 112 of the first, upper section 110 of the plunger assembly 106, is a clearance 140 (indicated on FIG. 5).

A central drilling 116 is provided in the first, upper section 110 of the plunger assembly 106, axially along a longitudinal axis A of the plunger assembly 106. The axial drilling 116 opens at a first, upper end 152 (remote from the second section 120 of plunger assembly 106), to an annulus 142 provided in the bore 108 of the housing 104; the annulus 142 ensures that the pumped fuel is not restricted.

The central drilling 116 opens at a second, lower end 154 (remote from the first end 152), onto the clearance 140 between the base 150 of the recess 112 of the first section 110 and the end 124 of the extension section 122 of the second section 120.

A pressure reducing feature comprising, which in the present embodiment comprises a radial recess 126 (indicated on FIG. 4) in an outer diameter of the plunger assembly 106. The radial recess 126 has been exaggerated in FIG. 4 for illustrative purpose. The radial recess 126 extends along part of the outer diameter of the first section 110 of the plunger assembly 106 and along part of the outer diameter of the second section 120 of the plunger assembly 106, and is subject to a fuel feed, cambox or return line pressure during use of the pump head 102.

During use of the pump head 102, the annulus 142 is exposed to pumping pressure, and therefore, an internal space of the plunger assembly 106, comprising the internal drilling 116 in the first section 110, and the clearance 140 between the first section 110 and the second section 120, are also open to pumping pressure.

A pressure gradient, indicated by arrows P on FIGS. 4 and 5, occurs along an outer wall 190 of the first section 110 of the plunger assembly 106, i.e. the pressure is at its greatest value at the top of the outer wall 190 of the first section 110, and decreases moving away from the annulus 142 (i.e. downwards in the orientation of the Figures), towards a first, upper edge 196 (indicated on FIGS. 4 and 5) of the radial recess 126, which is subject to fuel feed, cambox or return line pressure during use of the pump head 102.

The pressure gradient P causes a radial inward force to be applied to the first section 110 of the plunger assembly 106, above the first, upper edge 196 of the radial recess 126; the inward force decreases with the pressure gradient moving towards the upper edge 196 of the radial recess 126.

High fuel pressure within the clearance 140 causes a radial outward force to be applied to part of the annular wall section 114 above the interference zone 130.

As a result of the radial inward and outward forces being applied to the first section 110, deformation of the first section 110 varies along the outer wall 190. Accordingly, clearance between the outer wall 190 of first section 110 and the bore 108 varies, generally decreasing moving downwardly in the orientation of the figures. In particular, the expanding zone 134 of the wall section 114 forms a minimum clearance zone 192 (indicated generally on FIGS. 4 and 5), at which clearance between the first section 110 and the bore 108 is at a minimum value.

Sealing across the plunger assembly 106 is provided by the reduced clearance between the first section 110 of the plunger assembly 106 and the bore 108; the sealing maintains the required pressure difference between the first, upper end 160 of the plunger assembly and the first, upper edge 196 of the radial plunger recess 126.

The stiffness of the expanding zone 134 of the first section of the plunger can be optimised to seal at different pump head pressures as required.

Furthermore, the position of the expanding zone 134 can be selected to ensure that the guidance zones 136, 138, are of sufficient length to support radial side loads encountered during use of the pump head 104.

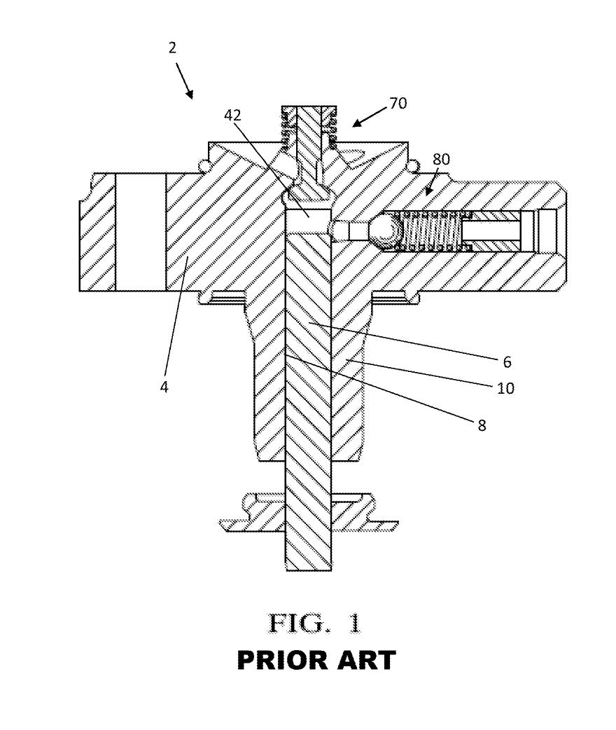

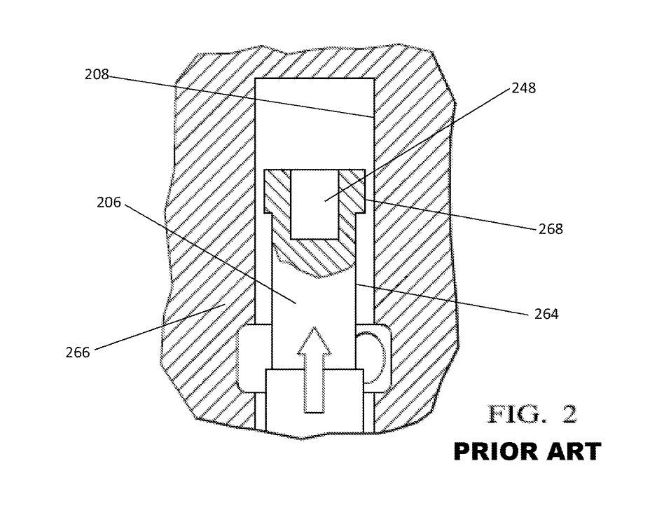

If the internal drilling of the prior art plunger of FIG. 2 were to be combined into a hydraulic pump head such as that illustrated in FIG. 1, a large dead volume penalty would be incurred, due to the necessary depth of the internal drilling in the plunger. The internal drilling would need to be deeper than the sealing length, to ensure a sufficiently large pressure difference across the plunger wall to cause it to expand and reduce the running clearance and therefore leakage, and would also need to be significantly deeper due to the configuration and location of the outlet port and annulus. The present invention enables the internal drilling of the prior art embodiment of FIG. 2 to be integrated into a hydraulic pump head such as that illustrated in FIG. 1, without incurring a large dead volume penalty.

The depth of the recess 112 in the first section 110, and accordingly the length of the extension section 122 of the second section 120, could be increased to suit manufacturing requirements, for example a deeper recess 112 would ease manufacture of the internal drilling 116.

Furthermore, the form of the extension section 122 of the second section 120, and that of the recess 112 of the first section 110, may be different to those illustrated in the Figures.

Although in the embodiment described above, the pressure reducing feature comprises a radial recess 126, in alternative embodiments, an alternative pressure reducing feature could be provided, such as axial grooves, or any other feature which reduces the pressure towards the lower end of the plunger assembly 106, remote from the annulus 142.

### REFERENCES

Prior art

FIG. 1

pump head 2

pump housing 4

plunger 6

bore 8

turret portion 10

annulus 42

inlet valve arrangement 70

outlet valve arrangement 80

FIG. 2

plunger 206

bore 208

central drilling 248

recess 264

barrel 266

full diameter section 268

Invention

pump head 102

pump housing 104

plunger assembly 106

bore 108

plunger first, upper section 110

plunger first section recess 112

first section annular wall section 114

first section central drilling 116

plunger second, lower section 120

plunger second section extension section 122

extension section end 124

plunger radial recess 126

interference zone 130

flexible portion (of first section) 134

guidance zones 136, 138

clearance 140

bore annulus/pumping chamber 142

first section recess base 150

axial drilling first, upper end 152

axial drilling second, lower end 154

plunger first, upper end 160

plunger second, lower end 162

inlet valve arrangement 170

outlet valve arrangement 180

first section outer wall 190

minimum clearance zone 192

first, upper edge of radial recess 196

longitudinal axis A

pressure gradient P

1. A plunger assembly for use in a pump head for a high pressure fuel pump for a vehicle, the pump head comprising a pump housing, provided with a bore in which the plunger assembly is arranged for reciprocating movement thereby to cause a pressure difference across the plunger assembly from a first end of the plunger assembly proximate to a chamber, to a first edge of a pressure reducing feature;
wherein the plunger assembly comprises at least a first section proximate to the chamber, and a second section remote from the chamber;
and wherein in use of the pump head,
an outer wall of the first section is subjected to a pressure which decreases moving away from the chamber, and an internal portion of the plunger assembly is subjected to a pumping fuel pressure;
and wherein the first section is caused to deform outwardly towards the bore of the housing, thereby decreasing a clearance between the outer wall of the first section and the bore, such that an area of reduced clearance between the outer wall of the first section and the bore provides sealing between the first end of the plunger assembly and the first edge of the pressure reducing feature.

2. A plunger assembly as claimed in claim 1 wherein the first section comprises an expanding zone wherein, during use of the pump head, the expanding zone is caused to expand by fuel pressure within the clearance and thereby form a zone of minimum clearance between the first section and the bore.

3. A plunger assembly as claimed in claim 1 wherein the internal portion of the plunger assembly which is subjected to the pumping fuel pressure comprises an internal drilling, and a second clearance between the first section and the second section, wherein the internal drilling opens at an upper end remote from the second section of the plunger assembly onto the chamber, and opens at a lower end onto the second clearance.

4. A plunger assembly as claimed in claim 1 wherein the pressure reducing feature comprises a radial recess which extends over portions of outer diameters of the first section and the second section of the plunger assembly and which, during use of the pump head is exposed to a fuel feed, cambox or return line fuel pressure.

5. A plunger assembly as claimed in claim 1 wherein the pressure reducing feature comprises axial grooves.

6. A plunger assembly as claimed in claim 1 wherein an extension section of the second section of the plunger assembly is retained within a recess provided in the first section by an interference fit along an interference zone between the extension section and an annular wall section which circumferentially defines the recess.

7. A pump head for a high pressure fuel pump for a vehicle, comprising a plunger assembly in accordance with claim 1.

8. A plunger assembly as claimed in claim 2 wherein the internal portion of the plunger assembly which is subjected to the pumping fuel pressure comprises an internal drilling, and a second clearance between the first section and the second section, wherein the internal drilling opens at an upper end remote from the second section of the plunger assembly onto the chamber, and opens at a lower end onto the second clearance.

9. A plunger assembly as claimed in claim 2 wherein the pressure reducing feature comprises a radial recess which extends over portions of outer diameters of the first section and the second section of the plunger assembly and which, during use of the pump head is exposed to a fuel feed, cambox or return line fuel pressure.

10. A plunger assembly as claimed in claim 2 wherein the pressure reducing feature comprises axial grooves.

11. A plunger assembly as claimed in claim 2 wherein an extension section of the second section of the plunger assembly is retained within a recess provided in the first section by an interference fit along an interference zone between the extension section and an annular wall section which circumferentially defines the recess.
